(19) United States
(12) Patent Application Publication
(10) Pub. No.: US 2020/0376476 A1
(43) Pub. Date: Dec. 3, 2020

(54) Method of Chemical Conversion Using Microwave-Active Catalysts

(71) Applicant: United States Department of Energy, Washington, DC (US)

(72) Inventors: Dushyant Shekhawat, Morgantown, WV (US); Mark W. Smith, Fairmont, WV (US); David A. Berry, Morgantown, WV (US); Christina Wildfire, Morgantown, WV (US); Victor Abdelsayed, Morgantown, WV (US); Michael Spencer, Morgantown, WV (US)

(73) Assignee: United States Department of Energy, Washington, DC (US)

(21) Appl. No.: 16/889,433

(22) Filed: Jun. 1, 2020

Related U.S. Application Data
(60) Provisional application No. 62/854,681, filed on May 30, 2019.

(51) Int. Cl. B01J 35/00; B01J 35/02; B01J 19/12

(52) U.S. Cl. CPC B01J 35/0033; B01J 2219/00141; B01J 19/126; B01J 35/026

(57) ABSTRACT

A method of enhancing a chemical reaction. The method includes providing catalyst particles with a predefined geometric shape having at least one of edges and points; and applying microwave energy to the catalyst particles, enhancing catalytic activity of the catalyst particles without increasing bulk temperature of surrounding reactants.

### CROSS-REFERENCE TO RELATED APPLICATIONS

This patent application claims priority from provisional patent application 62/854,681 filed May 30, 2019, which is hereby incorporated by reference.

### STATEMENT OF GOVERNMENT SUPPORT

The United States Government has rights in this invention pursuant to the employer-employee relationship of the Government to the inventors as U.S. Department of Energy employees and site-support contractors at the National Energy Technology Laboratory

### FIELD OF THE INVENTION

One or more embodiments consistent with the present disclosure relate to catalysts, more specifically microwave-active catalysts.

### BACKGROUND

The disclosure provides a system and method for chemical conversion using a microwave-enhanced catalytic process.

Over the past decades, there has been an increased number of studies related to microwave chemistry and their enhancement for chemical processes. The most common method of converting feedstocks to other products is through a thermal catalytic approach typically at high temperatures and pressures. For these processes thermal energy is used, and in the case of electro-catalysis, energy is supplied in the form of electrical potential. Along the lines of an electro-catalyst, a sustainable alternative is a photo-catalyst. Here the potential is generated on the catalyst surface through a photo-generated current.

Each of these different approaches have their own limitations. Thermal processes require reactors that can handle high pressure and temperature streams, with the additional burden of energy required to achieve these pressures. Similarly, with the photo-catalyst, there are limitations on the amount of potential that can be generated efficiently before becoming a defunct thermo-catalyst.

In providing an alternative approach, the embodiments utilize a microwave-enhanced catalyst approach that is aimed at generating high localized electric fields at the catalytic sites that permit new processing windows. These localized fields emulate the high potentials not achievable from a photo-catalyst and the new processing window permits the streams to be at lower temperature and pressure. The reaction is intensified using microwaves because it provides selective heating to active sites and lowers the activation energy. This, in turn, provides a scenario where the microwave-enhanced catalyst approach could outperform other approaches.

These and other objects, aspects, and advantages of the present disclosure will become better understood with reference to the accompanying description and claims.

### SUMMARY

Embodiments of the invention relate to a method of enhancing a chemical reaction. The method includes providing catalyst particles with a predefined geometric shape having at least one of edges and points; and applying microwave energy to the catalyst particles, enhancing catalytic activity of the catalyst particles without increasing bulk temperature of surrounding reactants.

One or more embodiments relate to the predefined geometric shape having at least one of a cube or cubic, spiked and a faceted cube. Further embodiments are contemplated in which the catalyst particles are comprised of dielectric materials including deposited metals.

### BRIEF DESCRIPTION OF THE DRAWINGS

These and other features, aspects, and advantages of the multiple embodiments of the present invention will become better understood with reference to the following description, appended claims, and accompanied drawings where:

FIG. 1 illustrates a microwave reactor setup with a fixed bed catalyst;

FIG. 2A illustrates an SEM micrograph of a copper (I) oxide microcrystal having cubic structure, FIG. 2B illustrates an SEM micrograph of a copper (I) oxide microcrystal having a spiked structure; FIG. 2C illustrates an SEM micrograph of a copper (I) oxide microcrystal having a faceted 8-pod cubic structure;

FIG. 3 illustrates a plot of the XRD pattern for Cu₂O, Cu, and CuO particles and the associated powders;

FIG. 4 illustrates the calculated polarizability in the y-direction for spiked Cu₂O particles at four difference volume fractions;

FIG. 5 illustrates the electric fields at zero phase angle for a Cu₂O spiked particle at two volume fractions with contour colors associated with field strength and a single iso-surface at 3×10⁺⁶ V/m plotted within the volume;

FIG. 6A illustrates the comparison between a conductive network of iron particles and a dispersed non-conductive network of iron particles within a microwave field and FIG. 6B illustrates the catalytic performance of a conductive and distributed catalyst system; and

FIG. 7A illustrates a TEM image of representative angular multi-pod particles with varying length features and FIG. 7B illustrates the mass spectrometer data from the microwave reaction of the multi-pod particles from FIG. 7A.

### DETAILED DESCRIPTION

The following description is provided to enable any person skilled in the art to use the invention and sets forth the best mode contemplated by the inventor for carrying out the invention. Various modifications, however, will remain readily apparent to those skilled in the art, since the principles of the present invention are defined herein specifically to provide a description of altering a catalyst's active sites for a microwave reaction to improve selectivity or alter the products of the reaction.

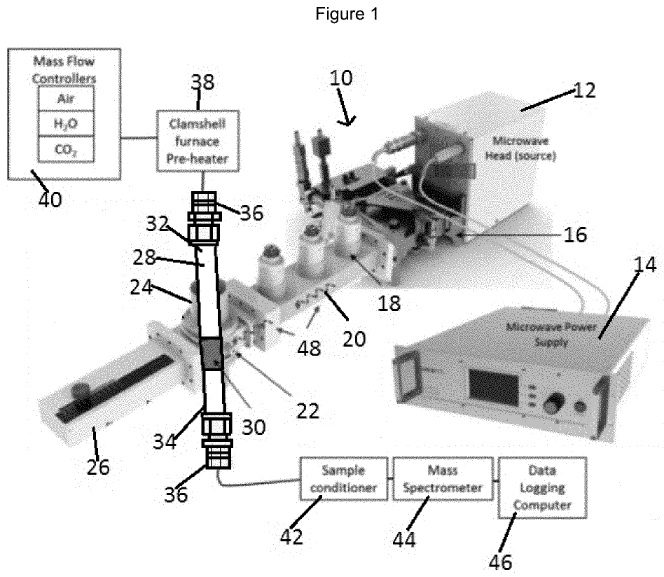

FIG. 1 illustrates a microwave catalytic reactor system 10 in accordance with one embodiment of the present invention. The microwave field may operate within the frequency range of 3 KHz to 300 GHz. The microwave field may be operated in a pulsed mode of 10⁻⁶-10s. The microwave field may be oriented in parallel or perpendicular to the gas flow through the catalyst bed.

FIG. 1 illustrates microwave head or source 12 coupled to microwave power supply 14. As illustrated, microwave source 12 includes a built in isolater 16 which prevents damage to the microwave source 12 even at 100% reflected power. Microwave source 12 is coupled or connected to tuner 18, a 3-stub tuner used for impedance matching. Sysem 10 includes a waveguide 20 coupled or connected to tuner 18. In at least one embodiment, microwave field 48 is confined within waveguide 20. An IR pyrometer 22 is shown coupled or connected to the waveguide 20 and a downstream source section 24. A sliding short circuit 26 is illustrated coupled to downstream source section 24, such that the sliding short circuit 26 is used for tuning or matching.

FIG. 1 further illustrates tube 28, a quartz tube for example, including fixed bed 30 and opposing ends 32 and 34. As illustrated, fixed bed 30 is shown proximate to and in communication with IR pyrometer 22 and sliding short circuit 26. In at least one embodiment, the IR pyrometer 22 includes a window, enabling measuring temperature of the fixed bed 30.

FIG. 1 illustrates tube 28 having opposing end 32 and 34, each opposing end 32 and 34 including a conax adaptor 36. A preheater 38, a clambshell furnace preheater for example, is shown coupled to opposing end 32. A source or mass flow controller 40 is coupled to preheater 38, where the source or mass flow controller 40 enables control of a gas flow including Air, H₂O and CO₂ for example, although different or additional gasses are contemplated. Additionally, opposing end 34 of tube 28 is shown coupled to sample conditioner 42, with a mass spectrometer 44 shown connected to sample conditioner 42, while a data logging computer 46 is shown connected to mass spectrometer 44.

Catalyst particles are placed wtihin the quartz tube 28 in the fixed bed location 30 and the gas is flowed down over the particles while being bombarded by microwave radiation. This embodiment targets a wide range of applications; converting hydrogen (syngas) to longer chain hydrocarbons; ammonia synthesis, hydrocarbon reforming, non-oxidative methane dehydroaromatization, non-oxidative coupling of methane, oxidative coupling of methane, hydrocarbon reforming, hydrocarbon decomposition, NOx decomposition, etc.

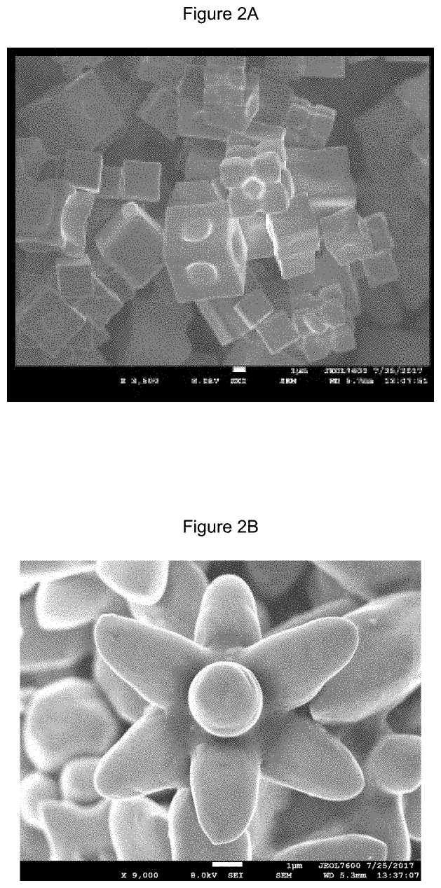

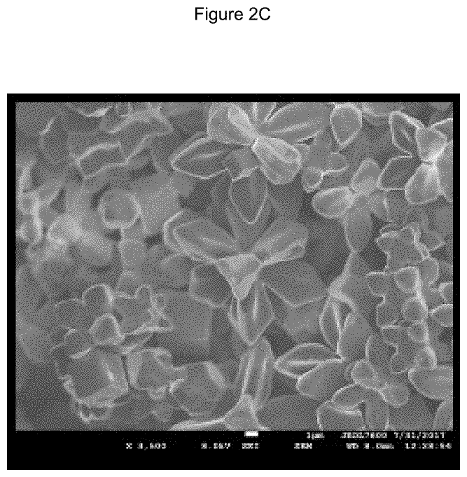

In one exemplary embodiment, cuprous oxide was synthesized with three different shape morphologies. The morphologies of these particles were analyzed by SEM and the images are shown in FIGS. 2A, 2B, and 2C. Each batch of particles had a similar particle size ranging from 5 μm to 10 μm with good uniformity in particle morphology. These morphologies include cube, spiked, and faceted cube. FIG. 2A shows cubic particles and FIG. 2B shows spiked particles. FIG. 2C shows particles with a third structure which is a faceted 8-pod cubic structure. The geometry and distribution of the particles determines the electric/magnetic field intensification and can be tailored to the reaction.

Various methods of synthesizing different morphologies of catalyst particles of well-defined shapes have been reported in the literature. In one embodiment, the catalyst particles were produced similar to the used to produce copper oxide synthesis. Synthesis of the catalyst may include, but is not limited to, hydrothermal, microwave-assisted hydrothermal, co-precipitation, and wet impregnation.

The first morphology synthesized was cubic particles, as shown in FIG. 2A, ranging in size from 5 μm to 10 μm. The cubic particles were a mixture of solid cubes with a shallow void space on the center faces of the cube due to the rapid growth of the outer crystal planes.

The second morphology synthesized was a spiked particle, as shown in FIG. 2B, with arms that are slightly rounded but provide a wide angle between the spokes and a sharp point at the ends.

The third morphology synthesized was a faceted 8-pod cubic structure, as shown in FIG. 2C, which grew to around 5 μm and has more angular features.

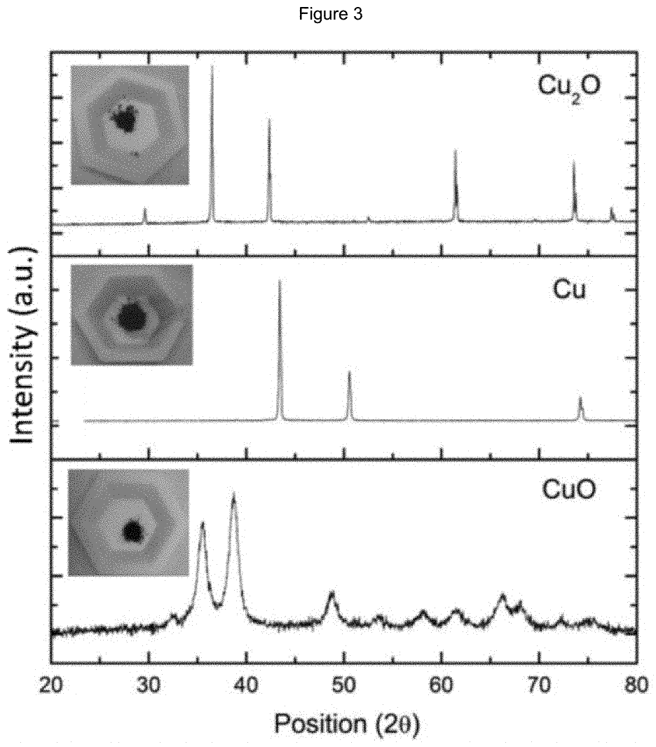

The crystal phase of the synthesized powders was characterized using an X-Ray diffraction (XRD) system. XRD patterns were analyzed based on the Rietveld refinement method using a pseudo-Voight function to model the peak profile. FIG. 3 illustrates a plot of the XRD pattern of the dried particles. The XRD patterns illustrate the cubic Cu₂O without any noticeable impurities in the phase. FIG. 3 shows particles with a nominal size of approximately 5 μm, but the particle size may be 10 nm≤dₚ≤1 mm. Each plot also includes a depiction of the associated powder, which exhibits a reddish hue for Cu₂O.

Cuprous oxide exhibits diamagnetic properties at low temperatures (<5 K) and for octahedron shapes. However, at room temperature, all cuprous oxide shapes exhibit ferromagnetic properties. The ferromagnetic properties arise from the spin polarization or difference in spin population of the spin-up and spin-down electrons. The unit cell of cuprous oxide is cubic with oxygen situated on a body-centered lattice and copper on a face-centered sublattice. Cuprous oxide is also a p-type semi-conductor that exhibits moderate electronical conductivity that is mostly attributed to small polaron hopping and the partial pressure of oxygen. Cuprous oxide exhibits a moderate direct band gap of 2 eV.

The dielectric properties of a heterogeneous catalyst are helpful to understand the response of the catalyst during irradiation. In the medium-frequency regime (10⁹-10¹² Hz) dipole effects and bond relaxation control the permittivity and permeability of a material. Focusing on the dipole effect, an important quantity is the polarizability of a material. In linear materials, the electric polarizability takes the form of Equation (1), where P is the polarization vector, χ is the electric susceptibility, εᵣ is the complex permittivity (εᵣ=ε′+iε″), and E is the electric field.

P=χₑε₀E=(1−εᵣ)ε₀E (1)

The polarization vector can be interpreted as the volume denisty of electric dipoles within the material. Likewise, on the magnetic side, the magnetic polarizability takes the form of Equation (2), where M is the magnetization vector, H is the magnetic field, χₘ is the magnetic susceptibility and μᵣ is the compex permeability (μᵣ=μ′+iμ″).

M=χₘμ₀H=(1−μᵣ)μ₀H (2)

Follwing the constitutive relationships, when a microwave field interacts with a material the electric flux density is proportional to the applied electric field plus the induced polarizability (D=ε₀E+P). Similarly, the magnetic flux density follows a similar relationship (B=μ₀H+M). Tailoring the polarizations such that they are in phase with the incident fields to maximize the electric flux density will influence the catalysis process.

Dielectric measurements were made with a 7 mm diameter coaxial airline connected to a microwave network analyzer. The composites samples were prepared by uniformly mixing the Cu₂O powders in paraffin with a 1, 5, 10, and 15 vol % Cu₂O. The mixture was formed into a cylindrical plug with an outer diameter of 7 mm, inner diameter of 3 mm and a thickness of 18 mm. The permeability and permittivity of the composites were measured in the range of 1-5 GHz (this restriction was to avoid resonance issues within the coaxial test cell). There was not significant variation over this frequency for the given material.

Modeling software was employed to conduct analysis of the effect particle geometry has on the electromagnetic field. A finite difference time domain (FDTD) was used to predict the polarizability of the particles and the scattering parameters of a particle/paraffin composite material. Maxwell's equations were solved in the frequency domain.

Under the frequency domain assumption, it is assumed all dielectric properties are linear. The equilibrium frequency domain equation that is solved takes the form of Equation (3), where k₀ is the wave number of free space, σ is the electrical conductivity, and ω is the angular frequency.

$$∇ \times \frac{1}{{μ}_{r}} ( ∇ \times E ) - {k}_{0}^{2} ( {ɛ}_{r} - \frac{i σ}{ω {ɛ}_{0}} ) E = 0 \qquad ( 3 )$$

The term containing the electrical conductivity defines the finite conductivity loss. Dipole losses are contained within the imaginary terms.

The domain was constructed using a single unit cell representation of the particle surrounded by paraffin matrix. Reflective boundaries on the lateral edges and open boundaries on the top and bottom (ports). The frequency was specified to be 2.45 GHz, because there was no significant variation over the range of 1-5 GHz for the given material. The fields and scattering parameters were monitored at this frequency of 2.45 GHz.

The complex dielectric properties, which include the real and imaginary parts of both the permittivity (ε) and permeability (μ) were determined, along with the conductivity. For Cu₂O, those properties were: ε=8.8000+0.0821i and μ=1.0000+0.0240i. The Cu₂O properties were determined based on literature values. For paraffin, those properties were: ε=2.2023+0.0006i and μ=0.9934+0.0048i. The values for paraffin were based on the experimentally determined values, as shown in Table 1 . It should be appreciated that the permittivity of the particle is greater than the permittivity of the paraffin, but the particle has more loss than the paraffin.

The conductivity of Cu₂O was assumed to be 20 S/m. The conductivity of paraffin was assumed to be nearly zero, at 1×10⁻¹³ S/m. It should be appreciated that a current will be generated within the conductive particle that is proportional to the conductivity times the electric field.

The dielectric properties of the composite were calculated from the effective paraffin/particle properties and the known volume fraction of particles within the mixture. The calculation is carried out by solving the Maxwell-Garret effective medium mixing equation for the dielectric properties of the particle. The Nicholson-Ross-Weir method was used that provided a direct calculation of the permittivity and permeability from the scattering parameters.

Table 1 illustrates a table of experimentally determined dielectric properties of paraffin and Cu₂O particles mixture at 2.45 GHz and room temperature for various volume fractions. These values were experimentally determined using a network analyzer with coaxial dielectric measurement technique and the results were averaged over sample lengths.

TABLE 1

| Particle | | | | | | |
|---|---|---|---|---|---|---|
| Geometry | ∈′ | ∈″ | μ′ | μ″ | tan(δ_{∈}) | tan(δ_{μ}) |
| Paraffin | 2.2023 | 0.0006 | 0.9934 | 0.0048 | 0.0003 | 0.0048 |
| 100 vol % | | | | | | |
| Cubes | 2.2813 | 0.0148 | 0.9980 | 0.0085 | 0.0065 | 0.0085 |
| 5 vol % | | | | | | |
| Spiked | 2.2577 | 0.0119 | 0.9971 | 0.0056 | 0.0053 | 0.0056 |
| 1 vol % | | | | | | |
| Spiked | 2.2903 | 0.0179 | 1.0075 | 0.0096 | 0.0078 | 0.0095 |
| 5 vol % | | | | | | |
| Spiked | 2.3556 | 0.0160 | 1.0064 | 0.0104 | 0.0068 | 0.0103 |
| 10 vol % | | | | | | |
| Spiked | 2.4283 | 0.0167 | 1.0126 | 0.0079 | 0.0069 | 0.0078 |
| 15 vol % | | | | | | |

The values shown in Table 1 demonstrate a trend that the effective permittivity and permeability increases with increased complexity (from cube to spiked). For the spiked particles, as the volume fraction increases, the effective dielectric properties increase greater than what is predicted from simple mixing relationships. This is a result of neighboring interactions that increase the dipole density (polarizability) between particles and spiked tips.

The particles were set in paraffin at low volume percentages, well below the percolation limit to avoid the particles forming a conductive network. At room temperature, Cu₂O is a weak ferromagnetic and does not exhibit significant coupling with the associated magnetic field at this frequency. This is quantified with permeability values near unity. However, the permittivity values exhibit a noticeable modulation as a function of volume fraction and shape. The volumetric concentration of the catalyst particles within the reaction zone is 1≤VOL %≤30.

The dielectric properties were calculated by solving the Maxwell-Garret effective medium mixing equation for the dielectric properties of the particle. For a cube shape the dielectric properties was calculated to be ε=3.7891 at 5 vol %, and for the spike it was calculated to be ε=4.5586 at 5 vol %. This equates to a nearly 20% increase in permittivity by changing the shape of the particle from cube to spiked. Therefore, the dielectric properties can also be controlled by controlling the particle morphology of Cu₂O at microwave wavelengths.

The significant increase in permittivity values is due to localization of the fields of the material, specifically the increase in electric fields near the tips of the spiked particles. These localized electric fields increase the dipole density, or polarizability, within the paraffin in the proximity of the particle tips. From Equation (1) for a given electric field, an increase in polarizability must be directly related to an increase in complex dielectric constant.

Furthermore, the distance between particles, which is proportional to the volume fraction also influences the ability to generate electric fields between particles, as shown in Table 1 for the spiked particles at difference volume fractions. At higher volume fractions, the spacing between particles is decreased and this increases the electric field within the paraffin. This increase in the electric field between particles is manifested in an increase in measured effective dielectric properties.

The dielectric support material has a dielectric constant 2.0≤ε≤300. The dielectric support material has a magnetic constant 1.0≤μ≤100. The active phase is an electrically conductive material, including but not limited to metallic site, mixed metal oxide, or carbon. The active phase may be the dielectric or magnetic material with multiple, high-aspect ratio features. Or, the active phase may be deposited onto a dielectric or magnetic support material with multiple, high-aspect ratio features arranged in 3D configuration.

The microwave-catalyst interaction, dielectric, magnetic, or both, is used to enhance a specific step or steps within the overall reaction mechanism with ΔH>0. The catalyst may be chemically catalytic for the desire reaction without the application of the microwave field, but is enhanced by the intensification of the microwave field by the structure support on to which it is deposited. Or the catalyst may be chemically non-catalytic for the desired reaction without the application of the microwave field, but is activated by the interaction of the microwave field with the structured support on to which it is deposited.

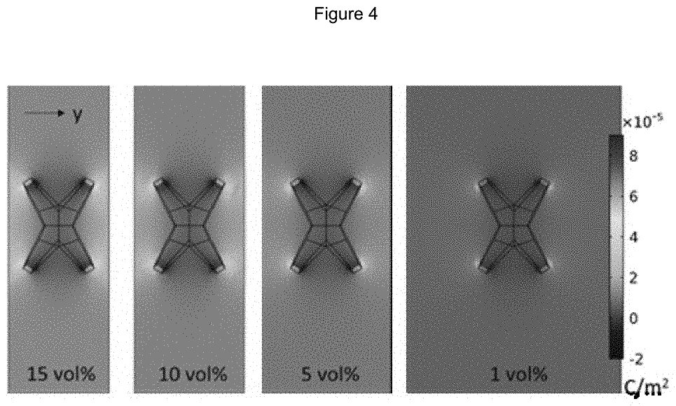

FIG. 4 illustrates the polarization in the y-direction for a 5 μm spiked particle at four different volume fractions (1 vol %, 5 vol %, 10 vol % and 15 vol %) associated with the experimental values, shown in Table 1. The color bar in FIG. 4 represents the polarization density in a plane that is placed at the intersection of the spike tips.

The contour plots are associated with a given snapshot in time or phase when the polarization is at a maximum. It is envisioned that these dipoles are turned on and off as the incident field interacts with the particles inducing a dipole in the paraffin. The particles have a larger permittivity than the paraffin. Therefore, the particles are more capacitive than the paraffin, but FIG. 4 shows the dipoles are generated in the paraffin. This is a result of the particles having such a high conductivity that they charge polarize quickly, generating a current within the particle. Plotting the current density from the simulation confirms this. A conductive particle that quickly polarizes can essentially act as a perfect electric conductor, where the surface charge must be proportional to the charge within the solid. This maximizes the electric field around the particle.

FIG. 4 shows the increase dipole density between particles with increasing volume fraction, as well as the location of the maximum. The high dipole density is within the paraffin near the spike tips.

The particle shape and the proximity of the particles relative to each other (volume fraction) influence the increase in effective dielectric properties. There is a drop in polarization with decreasing volume fraction or increasing spacing. At 1% volume fraction spiked particles, there is increased polarization near the tip of the particle in the paraffin.

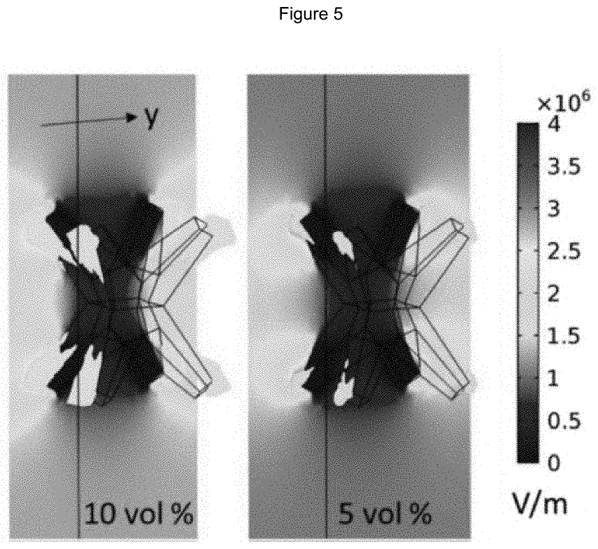

FIG. 5 depicts a plot of the electric field for two volume fractions, 10 vol % and 5 vol %. The electric field is plotted on a plane that intersects the tips and iso-surfaces (surface of the constant field, 3×10⁺⁶ V/m) are plotted. The highest associated electric field within this region is focused near the tips, similar to the polarization. This confirms that a localized field enhancement is realized at 2.45 GHz and it is located at the tips. The electric field within the particle is low because of the high conductivity of the particle.

FIGS. 4 and 5 only illustrate one orientation. All orientations must be accounted in order to achieve an increase in the effective properties and an increase in the particle dielectric properties. The highest electric field is achieved when the tips of the particle are oriented at each other.

Several parameters such as active catalytic sites and support, microwave power and pulsing scheme, and the physical properties of the catalyst material (dielectric properties, etc.) may affect the chemical conversions and product formation. Active site materials may include metals, magnetic materials, and other electrical and ionic conductors. Oxides that tend to be transparent to microwave fields may be typical catalyst supports.

Active sites are synthesized with a tailored shape and size distribution to increase the electric field between the particles. The most effective particle geometries have been those with sharp points/angles (stars, rods, etc.). The catalyst particles comprise multiple features with two or more different aspect ratios that correspond to different levels of intensification for reaction steps within the reaction mechanism requiring different amounts of energy for completion.

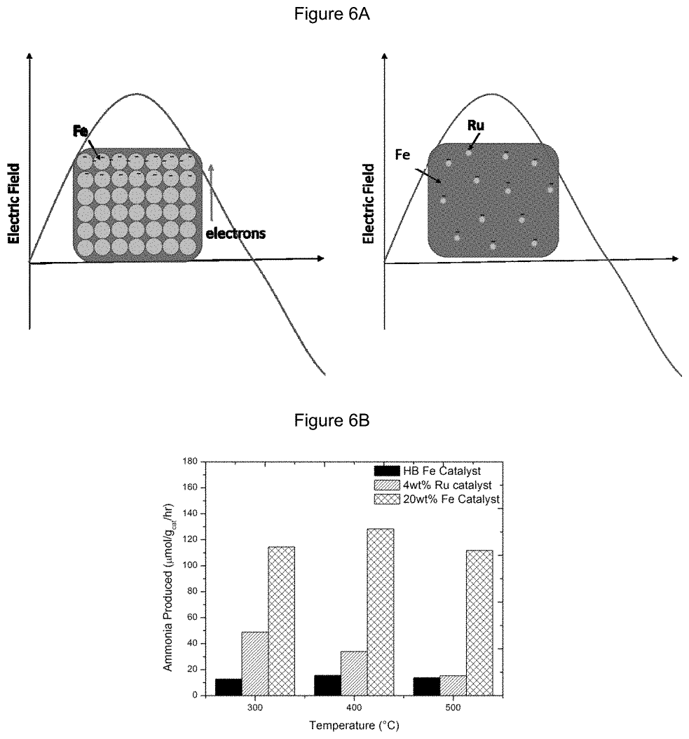

FIG. 6A illustrates the importance of the dispersion of the active site particles. If the volume 7 percent concentration of the electrically conductive particles exceeds the percolation point>30 vol %, the particles form a conductive network and cannot increase the electric field around or between them. When the particles remain below the percolation limit, the increased field can for example, generate electron donation lowering the activation energy of the reaction. This catalytic advantage is seen in FIG. 6B with the distributed iron having superior ammonia synthesis with less volumetric % of active site particles.

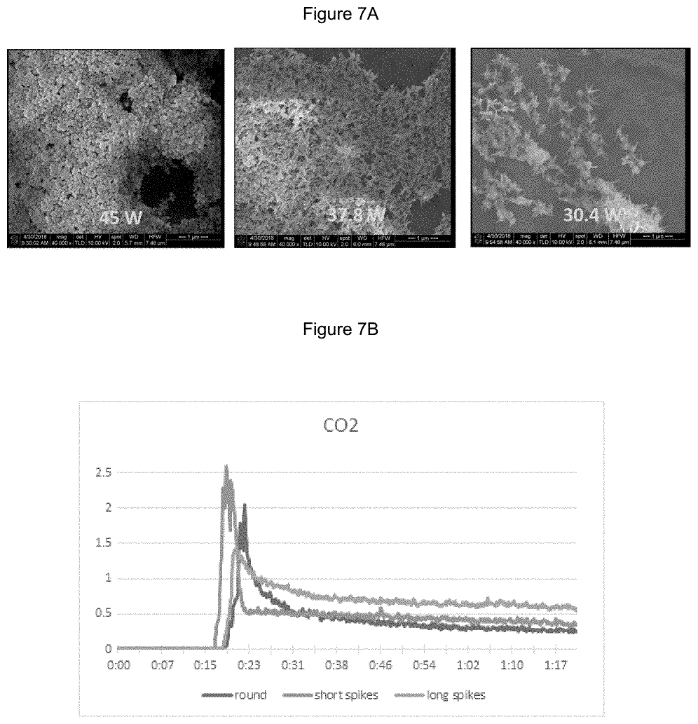

Particle geometry can also increase energy efficiency of the reaction. FIG. 7A illustrates round, short arm, and long arm multi-pods of Ni. As the arm length of the angular particles increased, the energy needed for reaction temperature decreased, demonstrating the geometry's effect on increased current within the particle. FIG. 7B illustrates the increased reaction rate for methane combustion as the arm length increases. Each catalyst was held at the same processing conditions.

Having described the basic concept of the embodiments, it will be apparent to those skilled in the art that the foregoing detailed disclosure is intended to be presented by way of example. Accordingly, these terms should be interpreted as indicating that insubstantial or inconsequential modifications or alterations and various improvements of the subject matter described and claimed are considered to be within the scope of the spirited embodiments as recited in the appended claims. Additionally, the recited order of the elements or sequences, or the use of numbers, letters or other designations therefor, is not intended to limit the claimed processes to any order except as may be specified. All ranges disclosed herein also encompass any and all possible sub-ranges and combinations of sub-ranges thereof. Any listed range is easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above. As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

One skilled in the art will also readily recognize that where members are grouped together in a common manner, such as in a Markush group, the present invention encompasses not only the entire group listed as a whole, but each member of the group individually and all possible subgroups of the main group. Accordingly, for all purposes, the present invention encompasses not only the main group, but also the main group absent one or more of the group members. The present invention also envisages the explicit exclusion of one or more of any of the group members in the claimed invention.

We claim:

1. A method of enhancing a chemical reaction, the method comprising:
providing catalyst particles with a predefined geometric shape having at least one of edges and points; and
applying microwave energy to the catalyst particles, enhancing catalytic activity of the catalyst particles without increasing bulk temperature of surrounding reactants.

2. The method of claim 1 wherein the predefined geometric shape is at least one of cubice, spiked and a faceted cube.

3. The method of claim 1 wherein the catalyst particles are comprised of dielectric materials including deposited metals.
